(19) United States
(12) Patent Application Publication
(10) Pub. No.: US 2008/0246252 A1
(43) Pub. Date: Oct. 9, 2008

(54) Heating device usable with a tractor trailer, a tractor trailer including the same, and a method of heating a tractor trailer

(76) Inventor: Vincent McDonald, Penns Grove, NJ (US)

Correspondence Address: BERENATO, WHITE & STAVISH, LLC, 6550 ROCK SPRING DRIVE, SUITE 240, BETHESDA, MD, 20817, US

(21) Appl. No.: 11/783,154

(22) Filed: Apr. 6, 2007

(51) Int. Cl. B62D 53/06; B60L 1/02

(52) U.S. Cl. 280/423.1; 219/202

(57) ABSTRACT

A vehicle trailer is provided. The vehicle trailer includes an elongated trailer for transporting cargo. A heating device includes an elongated waterproof mat disposed on a top surface of the trailer. The mat has a heating system for heating the mat. A power supply unit is operably associated with the heating system for operating the heating system and thereby causing the mat to be heated.

### FIELD OF THE INVENTION

The present invention relates to a heating device usable with a tractor trailer, a tractor trailer including the same, and a method of heating a tractor trailer.

### BACKGROUND OF THE INVENTION

Tractor trailers transport cargo all over the world. In cold climates, snow and ice can accumulate on top of tractor trailers, thereby creating a safety hazard on roads and highways. For example, snow and/or ice can billow or blow from the top of the tractor trailer and obstruct the view of drivers of vehicles near the tractor trailer. In some cases, the snow and/or ice can even hit cars or trucks or cause drivers to instinctively swerve out of the way of falling ice and snow. These hazards can result in serious accidents and injuries to the drivers on the road.

Not surprisingly, because of these dangers, many countries, cities, and states have established various ordinances and laws requiring drivers to clear their roofs of accumulated ice and snow, lest they face tickets and fines.

Unfortunately, clearing snow from the top of a tractor trailer can be difficult and dangerous work, requiring the driver to climb atop the roof of the tractor trailer and remove the snow manually every time snow and ice accumulates. In some cases, snow and ice can accumulate daily or even weekly during cold months.

Accordingly, there is a need for a safe and effective way of removing snow and ice from the top of a tractor trailer.

### SUMMARY OF THE INVENTION

According to a first aspect of the present invention, a vehicle trailer is provided. The vehicle trailer includes an elongated trailer for transporting cargo. A heating device includes an elongated waterproof mat disposed on a top surface of the trailer. The mat has a heating system for heating the mat. A power supply unit is operably associated with the heating system for operating the heating system and thereby causing the mat to be heated.

According to a second aspect of the present invention, a heating device usable with a trailer is provided. The heating device includes an elongated waterproof mat sized for disposition on a top surface of a trailer. The mat has a heating system for heating the mat. A securement system is disposed around the elongated waterproof mat for securing the elongated waterproof mat to the top surface of the trailer. A power supply unit is operably associated with the heating system for operating the heating system and thereby causing the mat to be heated.

According to a third aspect of the present invention, a method of heating a top surface of a trailer is provided. The method includes providing an elongated waterproof mat sized to be disposed on a top surface of a trailer. The elongated waterproof mat has a heating system for heating the mat. A plurality of clamps are provided and disposed around a perimeter of the top surface of the trailer. A power supply unit provides power to the heating system. The elongated waterproof mat is positioned on the top of the trailer. The elongated waterproof mat is clamped to the top of the trailer, and the heating system is operated thereby heating the top of the trailer.

### BRIEF DESCRIPTION OF THE DRAWINGS

FIG. 1 is a perspective view of a tractor trailer according to an embodiment of the present invention;

FIG. 2 is a side elevational view of a trailer according to an embodiment of the present invention;

FIGS. 3A and 3B are fragmentary side elevational views of a clamp used to anchor a heating mat according to the present invention;

FIGS. 4A and 4B are fragmentary cross-sectional views of a heating mat according to the present invention;

FIG. 5 is an exemplary equivalent circuit diagram of a heating device according to the present invention;

FIG. 6 is a block diagram of a heating system according to the present invention; and

FIG. 7 is a block diagram of a heating system according to another embodiment of the present invention.

### DETAILED DESCRIPTION OF THE INVENTION

Reference will now be made in detail to the embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

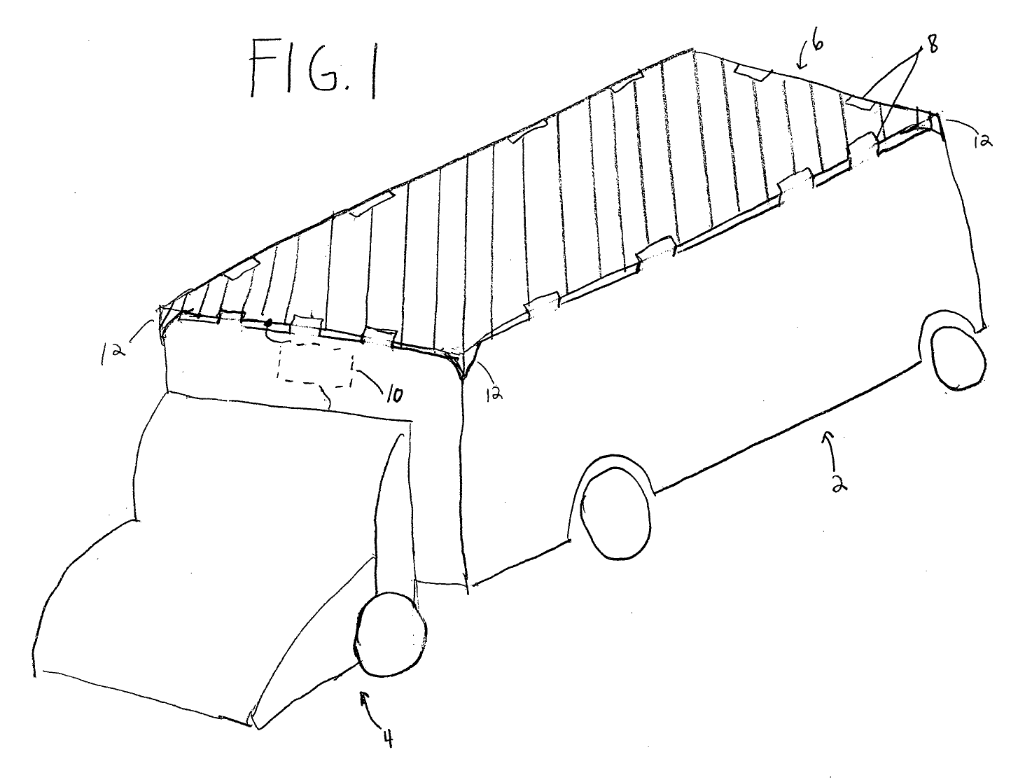

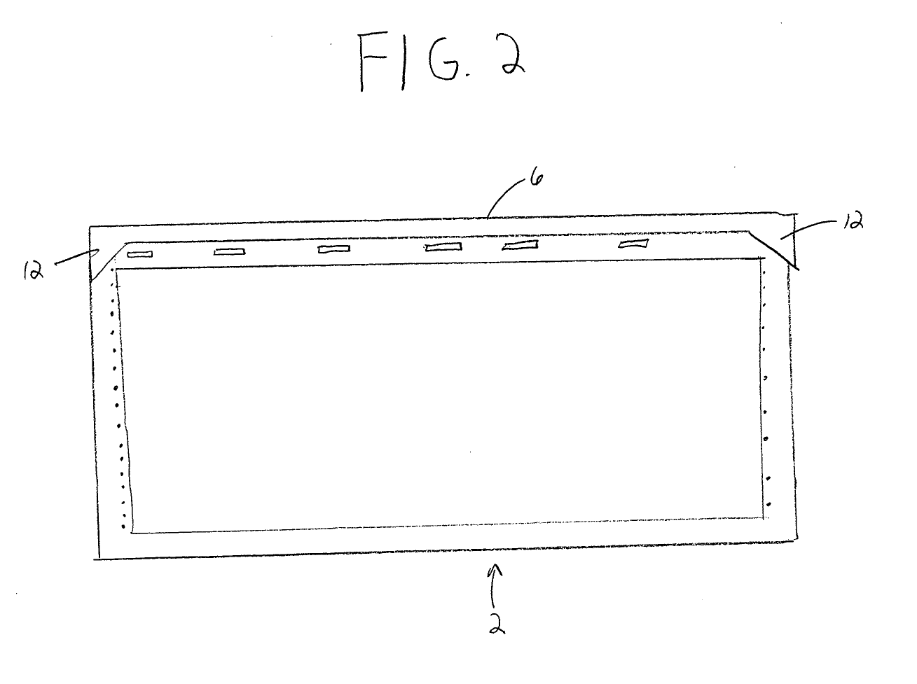

FIG. 1 illustrates a perspective view of a tractor trailer according to an embodiment of the present invention, and FIG. 2 illustrates a side view of a trailer 2. As best shown in FIG. 1, the trailer 2 can be connected to a cab (tractor) 4 that pulls the trailer 2.

The trailer 2 has a top surface on which a heating device 6 is disposed. The heating device 6 is a mat that is a suitable size for disposition on the top surface of the trailer 2. For example, for a trailer that is 40 feet in length and 8 feet and 6 inches in width, the heating mat 6 may be made roughly equal to these dimensions. Of course, the heating mat 6 may be made to have other sizes that correspond to other trailer sizes. The heating mat 6 is made of an electrically insulative and waterproof material (e.g., rubber) with at least one heating element disposed therein. Additionally, the heating mat 6 may be slip resistant.

Also as shown in FIG. 1, the heating mat 6 may have corner fittings 12 to fit around the four corners of the top surface of the trailer 2. As best shown in FIG. 2, the corner fittings 12 may be formed integrally with the material of the heating mat 6 such that the corner fittings 12 fit snugly on the respective corners of the trailer 2 to secure the heating mat 6 in place. To this end, the corner fittings 12 may be formed to have a 90 degree angle or an angle that is complementary to the corners of the trailer 2. The corner fittings 12 may have a triangular shape.

The heating mat 6 may be made of a resilient slip resistant material that allows some stretching to occur when the mat 6 is applied to the top surface of the trailer 2. As a result, when the heating mat 6 is secured on the top surface of the trailer 2, the heating mat 6 is not deformed by wind and no voids are formed between the mat 6 and the trailer 2. In this manner, wind resistance caused by the heating mat 6 when the trailer 2 is moving can be minimized.

In addition, a plurality of clamps 8 are disposed around a perimeter of the top surface of the trailer 2. The clamps 8 anchor the heating mat 6 to the top surface of the trailer 2. The clamps 8 provide added security to the heating mat 6, thereby preventing the heating mat 6 from catching air when the trailer 2 is moving at a high velocity.

The heating mat 6 may alternatively be sealed/adhered to the top surface of the trailer 6 by a suitable adhesive. For example, a silicone adhesive may be applied around a perimeter of the heating mat 6 between the trailer 2 and the mat 6. In this manner, the interface between the heating mat 6 and the trailer 2 may be sealed to prevent moisture from seeping therebetween while providing additional security to the heating mat 6.

A power supply unit 10 provides power to the heating mat 6 to heat the top surface of the trailer 2. In this manner, the heating mat 6 prevents ice and/or snow from accumulating on the top surface of the trailer 2.

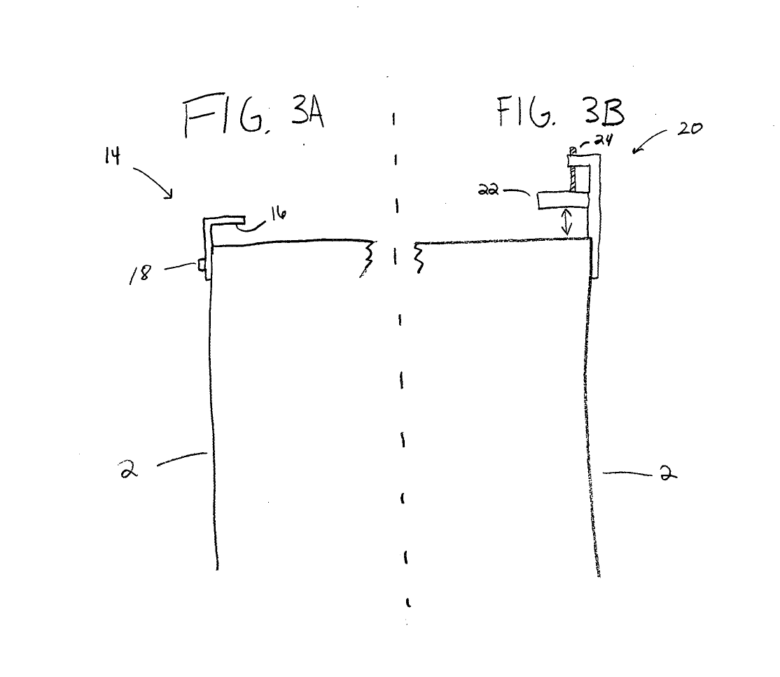

FIGS. 3A and 3B illustrate side views of clamps 14 and 20, respectively, used to anchor the heating mat 6 according to different embodiments of the present invention. As best shown in FIG. 3A, the clamp 14 is an L-shaped structure having a fixing element 18, such as a bolt or the like, to fix the clamp 14 to a side of the trailer 2 and a clamping surface 16 to contact the heating mat 6 and to maintain the heating mat 6 in a desired position.

As shown in FIG. 3B, the clamp 20 includes a movable clamping platform 22 connected to a rotational component (e.g., a screw) 24. The rotational component 24 is rotated to adjust the position of the movable clamping platform 22.

The clamps 14 and 20 may be welded to a side of the trailer 2 or may be fixed to the side of the trailer using other methods or fixing devices (e.g., a bolt, a screw, etc.). Additionally, the clamps 14 and 20 may be pre-installed on the trailer 2 (e.g., when the trailer 2 is manufactured) or may be arranged on the trailer 2 when the heating mat 6 (see FIGS. 1 and 2) is applied to the top surface of the trailer 2.

One of skill in the art will recognize that it is possible that other types of clamps and structures may alternatively be used to anchor the heating mat 6 to the trailer 2.

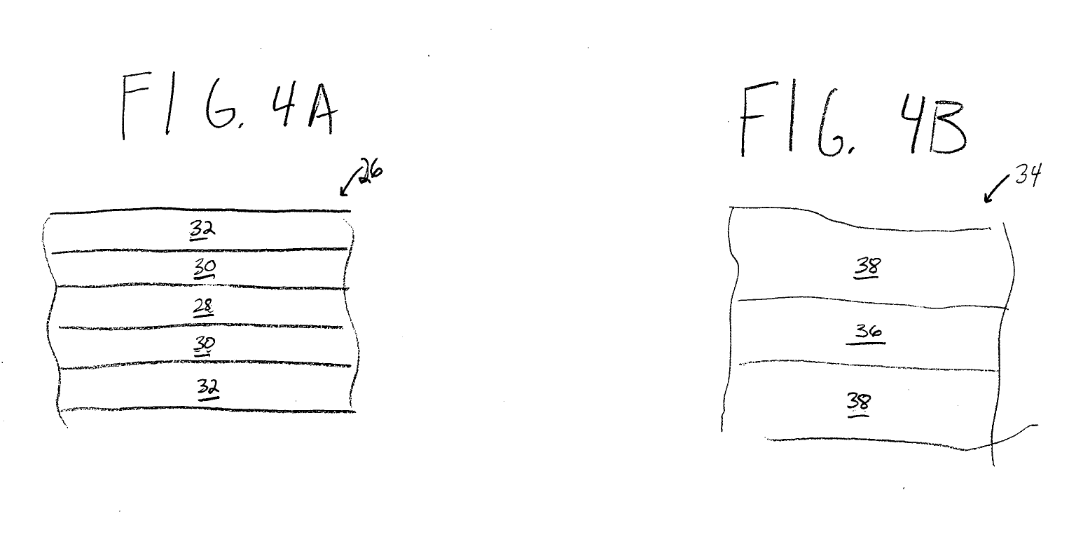

FIGS. 4A and 4B illustrate cross sectional views of the heating mat according to different embodiments of the present invention. As best shown in FIG. 4A, a heating mat 26 includes a heating layer 28 disposed between electrical insulation layer 30 and waterproof layer 32. The heating layer 28 may include a wire mesh having a plurality of heating elements wired therein. The waterproof layers 32 are manufactured to be watertight to prevent moisture from adversely affecting the heating mat 26. The electrical insulation layers 30 are formed of a suitable electrical insulator that allows effective heat transfer to the waterproof layers 32. In an exemplary embodiment of the present invention, the waterproof layers 32 may be made of rubber or another impermeable polymer, and the electrical insulation layers 30 may be made of an electrically insulative polymer, such as polyethylene, polyvinyl chloride (PVC), or the like, suitable for the purposes described herein.

As best shown in FIG. 4B, a heating mat 34 may include a heating layer 36 disposed between waterproof electrical insulation layers 38. In this manner, the thickness of the heating mat 34 can be minimized. The material for the waterproof electrical insulation layers 38 is selected such that the material provides waterproof electrical insulation to the heating layer 36, yet allows for effective heat transfer to melt surrounding ice/snow without melting the material. The heating layer 36 may be similar to the heating layer 28 shown in FIG. 4A.

It should be noted here that the materials used for the waterproof layers 32, the electrical insulation layers 30, and the waterproof electrical insulation layers 38 of FIGS. 4A and 4B are selected to have appropriate heat transfer properties.

The heating mats 26 and 34 may be made to have a thickness of about 1.5 inches. For example, each of the layers in the heating mat 34 may be made with a thickness of about 0.5 inches. The thickness of the heating mats 26 and 34 are selected so that the heating mats 26 and 34 do not pose clearance problems when the trailer 2 is moving underneath an overpass.

Additionally, the heating mats 26 and 34 are made to be heavy duty to withstand rain, wind, snow, etc.

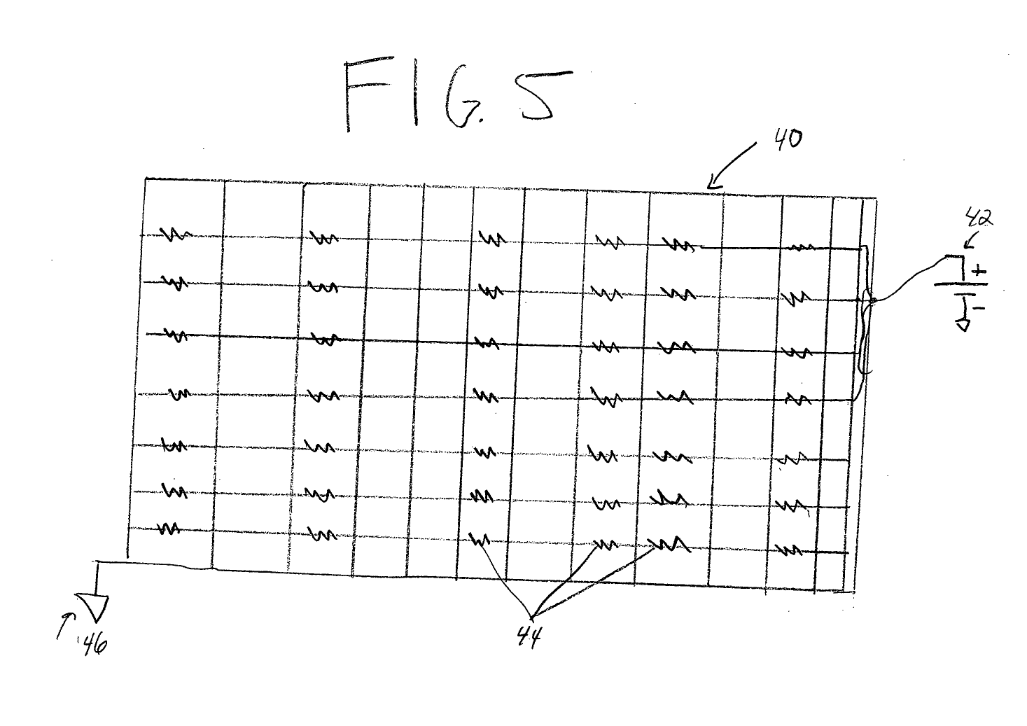

FIG. 5 illustrates an exemplary equivalent circuit diagram of the heating mat 6 according to an embodiment of the present invention. As best shown in FIG. 5, a heating circuit 40 includes a power source 42 that applies power to the heating circuit 40 and a circuit ground 46. The heating circuit 40 includes a plurality of heating elements 44 arranged throughout a grid. The heating elements 44 may be resistive elements that dissipate current to generate heat. The current provided by the power source 42 flows through the heating elements 44 to the circuit ground 46. The heating elements 44 may be wired in series or in parallel with each other. Preferably, the heating elements 44 are wired in parallel so as to prevent all of the heating elements 44 from failing if one of the heating elements 44 were to fail.

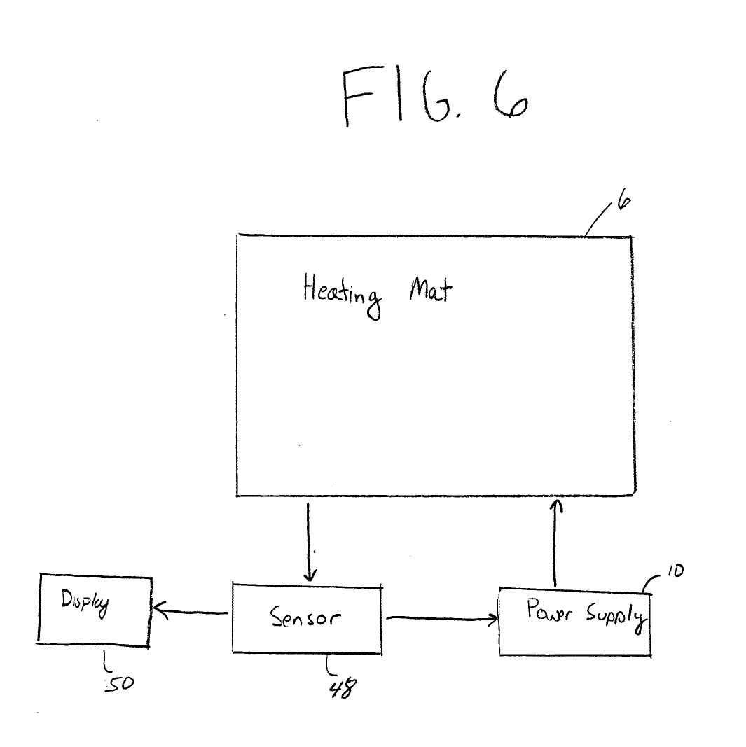

FIG. 6 illustrates a block diagram of a heating system according to an embodiment of the present invention. The heating system includes the heating mat 6 (shown in FIGS. 1 and 2), the power supply unit 10 shown in FIG. 1, a sensor 48, and a display unit 50.

The sensor 48 detects the presence of icy conditions, for example, by detecting an ambient temperature around the trailer 2 (see FIGS. 1 and 2) or the heating mat 6. In this case, the sensor 48 then provides the sensed temperature to the power supply unit 10 which determines whether the heating mat 6 should be supplied with power based on the sensed temperature. For example, the power supply unit 10 may compare the sensed temperature to a predetermined threshold temperature (e.g., freezing temperature) to determine whether the ambient temperature is less than the predetermined threshold temperature. If the ambient temperature is less than the predetermined threshold temperature, the power supply unit 10 can provide power to the heating mat 6. Here, the sensor 48 may include one or more sensors.

Alternatively, the sensor 48 may be an ice/snow sensor disposed about the heating mat 6 to detect ice/snow accumulation on the heating mat 6. For example, the sensor 48 may sense a weight of snow/ice on the heating mat 6. Accordingly, the sensor 48 provides information to the power supply unit 10 as to whether ice/snow has accumulated on the heating mat 6.

The heating system also includes a display unit 50 disposed inside the cab 4 (see FIG. 1 ) to display the information detected by the sensor 48. In particular, the display unit 50 may display the ambient temperature and/or whether there is any ice/snow accumulated on the heating mat 6.

The power supply unit 1 0 may be located inside the trailer 2 (see FIGS. 1 and 2), outside the trailer 2, or in the cab 4 (see FIG. 1). The power supply unit 10 can be powered by the engine of the cab 4 (not shown) or by a battery of the cab 4 (not shown). The power supply unit 10 may be housed in a weatherproof box. Alternatively, the heating mat 6 may be powered directly by the engine or the battery of the cab 4.

In an alternative embodiment, the heating mat 6 may be powered by manually using a switch disposed on or in communication with the power supply unit 10. In this case, a driver of the tractor trailer can ascertain whether ice/snow is present on the top surface of the tractor trailer using the display unit 50 and can activate the switch accordingly.

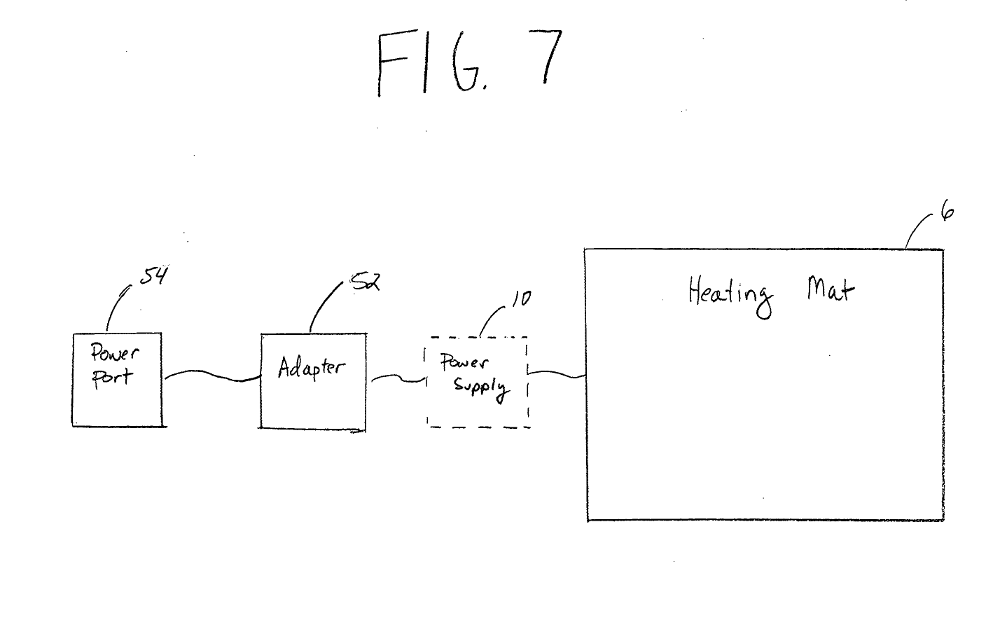

FIG. 7 illustrates a block diagram of a heating system according to another embodiment of the present invention.

The heating system includes the heating mat 6 (shown in FIGS. 1 and 2), the power supply unit 10 shown in FIGS. 1 and 6, an adapter unit 52, and a power output port 54. Here, the heating mat 6 can be powered to melt ice and snow from the top surface of the trailer 2 when the trailer 2 is parked in a loading dock (i.e., before the trailer 2 is operated by the cab 4). In this case, the loading dock includes the power output port 54 to which the adapter unit 52 is connected to power the heating mat 6 such that any ice/snow debris can be removed completely prior to operation.

The power supply unit 10 is represented by the dashed box, because the adapter unit 52 need not necessarily be connected to the heating mat 6 via the power supply unit 10. The adapter unit 52 may be connected directly to the heating mat 6. The adapter unit 52 converts the power from the power output port 54 of the loading dock to the power required by the heating mat 6. In some embodiments, the heating mat 6 may be made such that the power requirements are directly compatible with the power outlet port 54.

Accordingly, the heating mat 6 may be used to melt ice and snow while the trailer 2 and the cab 4 are being prepared (e.g., loaded, maintained, etc.) for operation. As a result, the ice/snow accumulated on top of the trailer 2 can be efficiently removed without setting aside additional time solely for removal of the ice/snow.

A method of applying the heating mat 6 (see FIG. 1) to the trailer 2 and heating the top surface of the trailer 2 will now be described with reference to FIGS. 1 to 3. First, the heating mat 6 is positioned on the top surface of the trailer 2. This step includes applying the corner fittings 12 of the heating mat 6 to the respective corners of the top surface of the trailer 2. Additionally, the heating mat 6 may be sealed to the top surface of the trailer 2 using, for example, a silicone adhesive.

The heating mat 6 is further anchored down to the trailer 2 by clamping the perimeter of the heating mat 6 down using the clamps 8. Here, the clamps 8 may be applied to the trailer 2 before or after the heating mat 6 is positioned on the trailer 2 in the manner described above with reference to FIGS. 3A and 3B. It should be understood that any number of clamps may be used to anchor the heating mat 6 to the trailer 2.

The heating mat 6 may be applied to the trailer 2 when cold weather and/or snow/ice is expected. For example, the heating mat 6 may be applied at the beginning of the winter season then removed at the beginning of the spring season. Due to the arrangement of the clamps 8 and the corner fittings 12 used to secure the heating mat 6 to the trailer 6, the heating mat 6 is easily removed and reapplied to the trailer 2. Therefore, the heating mat 6 need not be carried on the tractor trailer year around.

Although a few embodiments of the present invention have been shown and described, it will be appreciated by those skilled in the art that changes may be made in these embodiments without departing from the principles and spirit of the invention, the scope of which is defined in the appended claims and their equivalents.

I claim:

1. A vehicle trailer, comprising:
an elongated trailer for transporting cargo; and
a heating device including an elongated waterproof mat disposed on a top surface of said trailer, said mat having a heating system for heating said mat, and a power supply unit operably associated with said heating system for operating said heating system and thereby causing said mat to be heated.

2. The trailer of claim 1, further comprising:
a securement system including a plurality of clamps disposed around said top surface of said trailer to clamp said mat to said trailer.

3. The trailer of claim 2, wherein said clamps are secured to said trailer by welding or bolting.

4. The trailer of claim 1, wherein said mat includes a rectangular flat portion and a plurality of corner fitting portions formed integrally with said flat portion, said corner fitting portions extending downward at an angle with respect to said flat portion to fit corners of the top surface of said trailer therein.

5. The trailer of claim 4, wherein said mat comprises a resilient material having a size that is stretched to couple said corner fitting portions to said respective corners of said top surface of said trailer.

6. The trailer of claim 1, wherein a sealant adhesive is disposed between said mat and said trailer.

7. The trailer of claim 2, wherein said clamps each comprise an L-shaped structure having a clamping surface to contact and position of said mat.

8. The trailer of claim 2, wherein said clamps each comprise a movable platform vertically movable with respect to a top surface of said mat and a rotational component being rotatable to adjust a height of said movable platform.

9. A heating device usable with a tractor trailer, the device comprising:
an elongated waterproof mat sized for disposition on a top surface of a trailer, said mat having a heating system for heating said mat;
a securement system disposed around said elongated waterproof mat for securing said elongated waterproof mat to the top surface of the trailer; and
a power supply unit operably associated with said heating system for operating said heating system causing said mat to be heated.

10. The heating device of claim 9, wherein said mat comprises a heating layer disposed between waterproof insulation layers.

11. The heating device of claim 10, wherein said waterproof insulation layer comprises rubber.

12. The heating device of claim 9, further comprising:
an adapter unit connected between a power output port in a loading dock and said heating system so that said mat is heated before operation of the trailer.

13. The heating device of claim 9, wherein said mat is about 1.5 inches in thickness.

14. The heating device of claim 9, wherein said heating system comprises a heating circuit including a plurality of wires connected between a power source and a circuit ground and a plurality of resistive heating elements connected along the plurality of wires.

15. The heating device of claim 9, wherein said mat comprises an elongated flat portion for disposition on the top surface of the trailer and a plurality of corner fitting portions extending downward from said flat portion of said mat to fit corresponding corners of the trailer.

16. The heating device of claim 15, wherein said corner fitting portions are integrally formed with said elongated flat portion.

17. The heating device of claim 15, wherein said corner fitting portions form a 90 degree angle with respect to said flat portion of said mat.

18. The heating device of claim 9, further comprising:
a sensor operably associated with said power supply unit for determining whether ice/snow are present on top of the trailer,
wherein said power supply unit is programmed to automatically supply power to said heating system based on said determination of said sensor.

19. The heating device of claim 9, wherein said heating mat is made of a resilient material that is stretchable when said heating mat is applied to the top surface of the trailer.

20. A method of heating a top surface of a trailer, the method comprising the steps of:
providing an elongated waterproof mat sized to be disposed on a top surface of a trailer, the elongated waterproof mat having a heating system for heating the mat;
providing a plurality of clamps disposed around a perimeter of the top surface of the trailer;
providing a power supply unit to provide power to the heating system;
positioning the elongated waterproof mat on the top surface of the trailer;
clamping the elongated waterproof mat to the top surface of the trailer; and
operating the heating system thereby heating the top surface of the trailer.
